(19) United States
(12) Patent Application Publication
(10) Pub. No.: US 2026/0340514 A1
(43) Pub. Date: Oct. 29, 2026

(54) COLLECTIVE INTELLIGENCE SYSTEM LEVERAGING MULTIPLE ARTIFICIAL INTELLIGENCE MODELS

(71) Applicant: Dell Products L.P., Round Rock, TX (US)

(72) Inventors: Karan Kapoor, Bangalore (IN); Hung T. Dinh, Austin, TX (US); Bijan Kumar Mohanty, Austin, TX (US)

(21) Appl. No.: 19/188,558

(22) Filed: Apr. 24, 2025

(51) Int. Cl. G06N 20/20

(52) U.S. Cl. CPC G06N 20/20

(57) ABSTRACT

Methods, apparatus, and processor-readable storage media for implementing a collective intelligence system leveraging multiple artificial intelligence models are provided herein. An example computer-implemented method includes processing an input query using multiple artificial intelligence models in a collective intelligence system; evaluating responses to the input query generated by the multiple artificial intelligence models based on multi-dimensional evaluation metrics and one or more similarity measures; evaluating the multiple artificial intelligence models based on evaluating the responses generated by the multiple artificial intelligence models; determining, based on evaluating the multiple artificial intelligence models, at least one of the responses to be used as output from the collective intelligence system to at least one device associated with the input query; and performing one or more automated actions in connection with at least a portion of the artificial intelligence models in the collective intelligence system and based on the output from the collective intelligence system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Development involving artificial intelligence models are commonly focused on attempts to increase speed and reduce costs with respect to specific individual models. However, conventional artificial intelligence model development approaches typically require significant computational and storage costs associated with training and maintaining a model, and fail to produce and/or optimize individual models for multiple different purposes.

### SUMMARY

Illustrative embodiments of the disclosure provide a collective intelligence system leveraging multiple artificial intelligence models.

An example computer-implemented method includes processing at least one input query using multiple artificial intelligence models in a collective intelligence system, and evaluating responses to the at least one input query generated by the multiple artificial intelligence models based at least in part on multi-dimensional evaluation metrics and one or more similarity measures. Additionally, the method includes evaluating the multiple artificial intelligence models based at least in part on evaluating the responses to the at least one input query generated by the multiple artificial intelligence models, and determining, based at least in part on evaluating the multiple artificial intelligence models, at least one of the responses to the at least one input query to be used as output from the collective intelligence system to at least one device associated with the at least one input query. Further, the method also includes performing one or more automated actions in connection with at least a portion of the multiple artificial intelligence models in the collective intelligence system and based at least in part on the output from the collective intelligence system.

Illustrative embodiments can provide significant advantages relative to conventional artificial intelligence model development approaches. For example, problems associated with significant computational and storage costs and failure to produce and/or optimize individual models for multiple different purposes are overcome in one or more embodiments through facilitating enhanced output generation to heterogenous input queries using multiple artificial intelligence models as part of a collective intelligence with a scoring mechanism based at least in part on vector generation and processing.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing a collective intelligence system leveraging multiple artificial intelligence models in an illustrative embodiment.

FIG. 2 shows an example system architecture in an illustrative embodiment.

FIG. 3 shows an example workflow in an illustrative embodiment.

FIG. 4 shows example pseudocode for processing a query using a collective artificial intelligence model in an illustrative embodiment.

FIG. 5 shows example pseudocode for evaluating answers generated by multiple artificial intelligence models in an illustrative embodiment.

FIG. 6 is a flow diagram of a process for implementing a collective intelligence system leveraging multiple artificial intelligence models in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

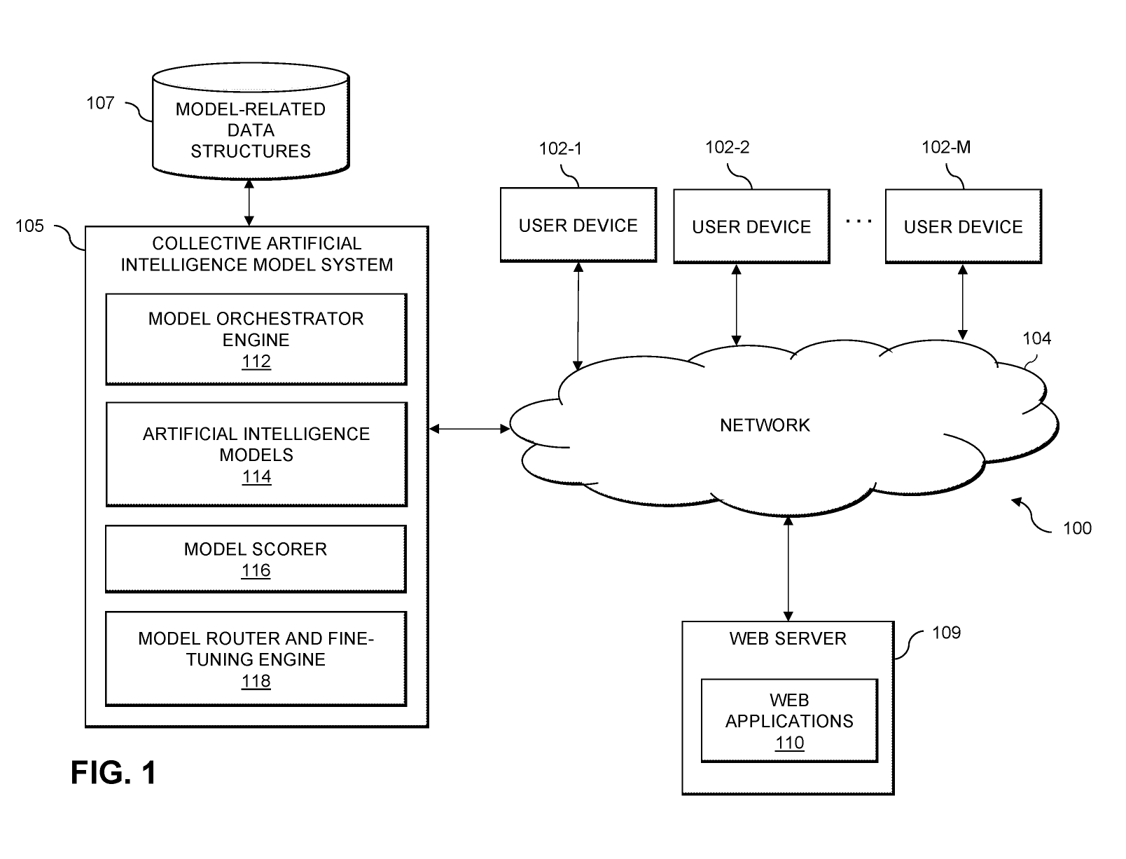

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is collective artificial intelligence model system 105 and web server 109, upon which one or more web applications 110 (e.g., virtual assistant applications, e-commerce applications, information technology support applications, telecommunication applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the collective artificial intelligence model system 105 can have one or more model-related data structures 107 configured to store data pertaining to model performance data, model execution task-related data, model query and response data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The model-related data structures 107 in the present embodiment are implemented using one or more storage systems associated with the collective artificial intelligence model system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the collective artificial intelligence model system 105 are one or more input-output devices, which illustratively comprise keyboards, displays or other types of input-output devices in any combination. Such input-output devices can be used, for example, to support one or more user interfaces to the collective artificial intelligence model system 105, as well as to support communication between the collective artificial intelligence model system 105 and other related systems and devices not explicitly shown.

Additionally, the collective artificial intelligence model system 105 in the FIG. 1 embodiment is assumed to be implemented using at least one processing device. Each such processing device generally comprises at least one processor and an associated memory, and implements one or more functional modules for controlling certain features of the collective artificial intelligence model system 105.

More particularly, the collective artificial intelligence model system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the collective artificial intelligence model system 105 to communicate over the network 104 with the user devices 102, and illustratively comprises one or more conventional transceivers.

The collective artificial intelligence model system 105 further comprises model orchestrator engine 112, artificial intelligence models 114, model scorer 116, and model router and fine-tuning engine 118.

In at least one embodiment, implementing the model orchestrator engine 112 can include processing at least one input query and transmitting such a query to the artificial intelligence models 114 for response generation. Additionally, in such an embodiment, implementing the model orchestrator engine 112 can include evaluating the model responses using multi-dimensional evaluation metrics and one or more similarity measures. Further, implementing the model scorer 116 can include evaluating the artificial intelligence models 114 based at least in part on the response evaluations, and determining, based at least in part on model evaluations, at least one of the responses to be used as output from the collective intelligence system to at least one device associated with the at least one input query. Also, in one or more embodiments, implementing the model router and fine-tuning engine 118 can include performing one or more automated actions (e.g., transmitting the determined response to at least one device, training at least a portion of the artificial intelligence models 114 using the best scoring model responses, etc.) in connection with at least a portion of the multiple artificial intelligence models in the collective intelligence system and based at least in part on the output from the collective intelligence system.

It is to be appreciated that this particular arrangement of elements 112, 114, 116 and 118 illustrated in the collective artificial intelligence model system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing a collective intelligence system leveraging multiple artificial intelligence models involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of collective artificial intelligence model system 105, model-related data structures 107, and web server 109 can be on and/or part of the same processing platform.

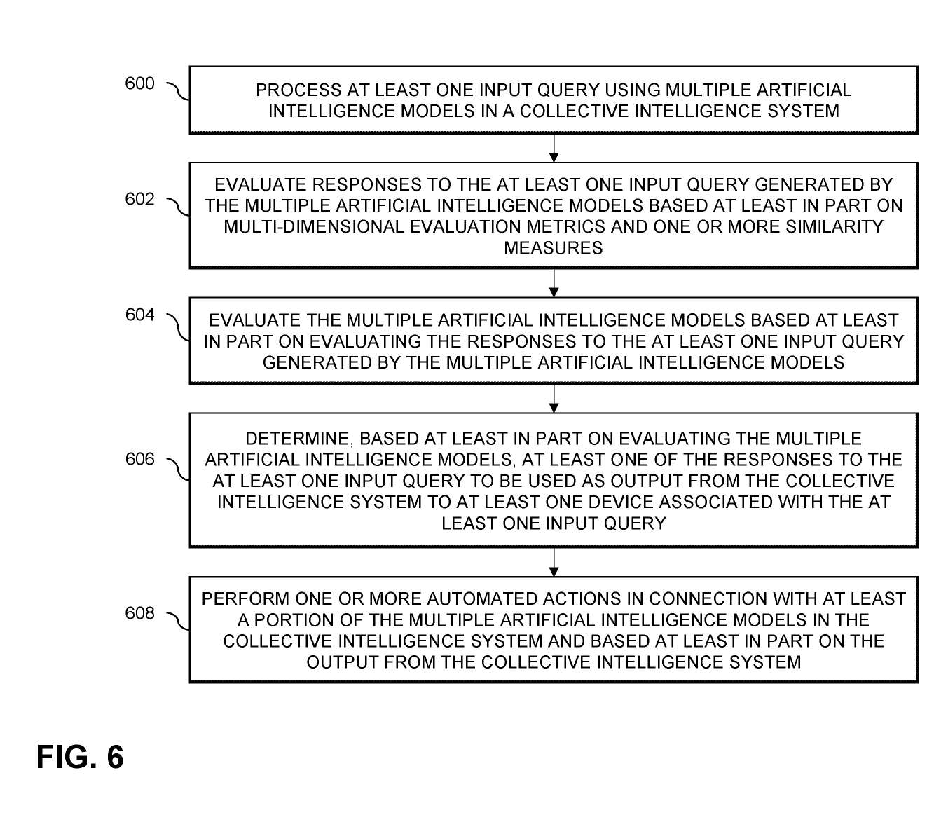

An example process utilizing elements 112, 114, 116 and 118 of an example collective artificial intelligence model system 105 in computer network 100 will be described in more detail with reference to the flow diagram of FIG. 6.

Accordingly, at least one embodiment includes generating and/or implementing a collective intelligence system leveraging multiple artificial intelligence models. The term “collective intelligence system” as used herein is intended to be broadly construed so as to encompass an intelligent framework for achieving emergent intelligence through a collective of multiple artificial intelligence models (e.g., decentralized hybrid artificial intelligence models) derived using collective intelligence behavior.

By way merely of illustration, in various software and cloud computing contexts, as distributed data processing features change dynamically due to user actions (e.g., user transactions, usage patterns, etc.) and instances scaling in and/or out across on-premise and cloud environments, it is important for a corresponding artificial intelligence model to be resilient to such dynamics. Accordingly, one or more embodiments include performing distributed data processing extraction processes in an automated manner, facilitating flexibility to distributed data processing changes with a high level of accuracy (e.g., to ensure related compliance assessments are accurate).

Due to limitations of conventional approaches, a use case such as, for example, deploying multi-cloud consumption licenses, often could not be accurately classified into corresponding license metrics mapped to designated entitlements. For instance, if a conventional approach included fine-tuning a single model to achieve the level of accuracy required for extracting license-related distributed data, the infrastructure costs to maintain such a model and the inaccuracies resulting from hallucinations specific to that model would likely prevent users from achieving the desired results with respect to compliance assessments and audits.

Accordingly, at least one embodiment includes inducing emergent behavior of higher intelligence using multiple artificial intelligence models as part of a collective intelligence with a scoring mechanism based at least in part on vector generation and processing. As further detailed herein, such an embodiment can include using a collective intelligence system to preclude the need to upgrade each individual model’s infrastructure, fine-tuning or performance. Also, in such an embodiment, the resulting collective intelligence system can, over time, execute different types of tasks, rendering it redundant to try to use specific individual models for specific needs. Additionally, model hallucinations can be validated with hallucinations and/or outputs from other models, thereby reducing the probability of transferring hallucinations into results validated across the collective. As used herein, a hallucination refers generally to an output of a large language model (LLM) that is plausible but factually incorrect. Hallucinations can occur due to a variety of factors including, for example, the type of LLM, the training data, a lack of domain context data, prompt, temperature settings of the model, etc. When multiple LLMs are used for a specific purpose and/or use case, LLMs’ accuracies can vary and hallucinations from one or more of the LLMs can also vary.

Further, as detailed herein, at least one embodiment includes transforming multiple individual artificial intelligence models into a collective model (also referred to herein as a super model) capable of dynamically improving over time, across one or more types of processing tasks, with internal competition and validation. Such an embodiment can include implementing real-time performance and accuracy monitoring for each individual model within the collective, which facilitates identifying and resolving inefficiencies without waiting for model scoring to accumulate across runs. Additionally or alternatively, one or more embodiments include configuring the collective model by selecting and/or pre-selecting a subset of the most relevant models based at least in part on prior performance (e.g., quickly eliminating poor performing models before detailed scoring). Such embodiments can include enabling a collective model to provide higher levels of accuracy with respect to detecting changes in data as well as in overall model performance than conventional single models.

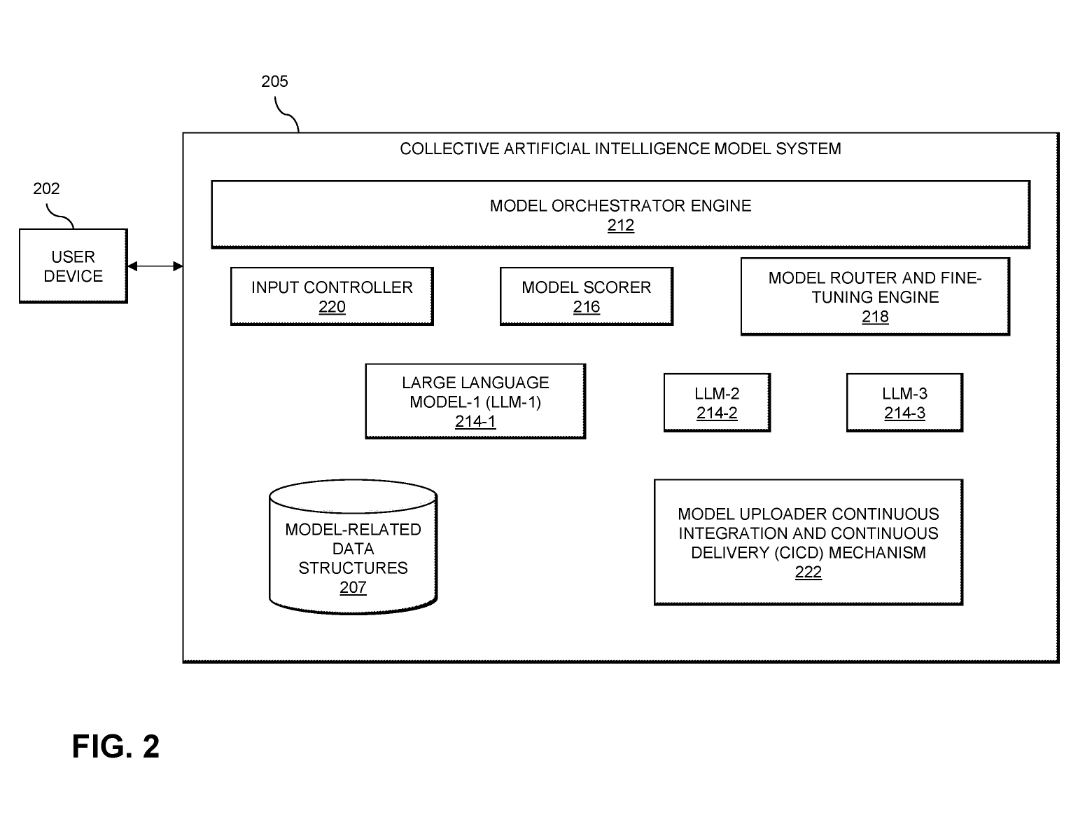

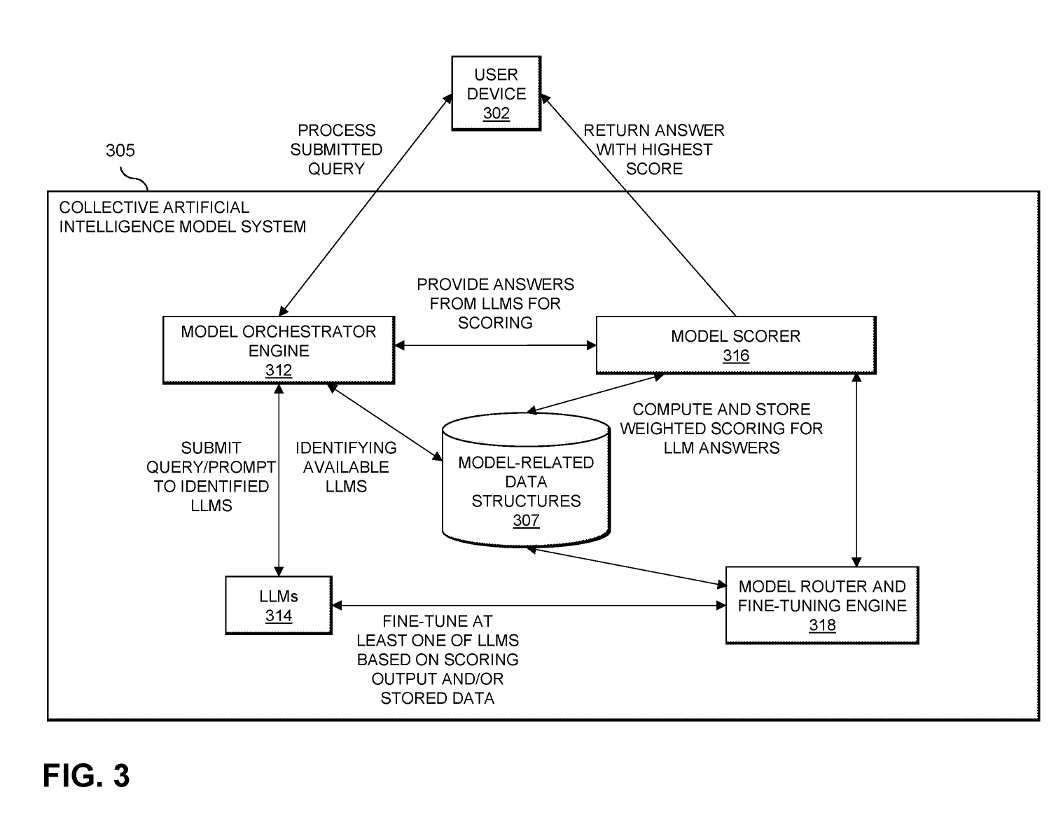

FIG. 2 shows an example system architecture in an illustrative embodiment. By way of illustration, FIG. 2 depicts user device 202 and collective artificial intelligence model system 205, which includes a collective of LLMs 214-1, 214-2 and 214-3 (referred to collectively as LLMs 214), model orchestrator engine 212, input controller 220, a model scorer 216, a model router and fine-tuning engine 218, a model uploader continuous integration and continuous delivery (CICD) mechanism 222, and model-related data structures 207. FIG. 2 depicts an example component view of a collective artificial intelligence model system 205, and an example workflow involving at least a portion of these components is described in connection with FIG. 3 below.

For example, a query and/or question submitted from user device 202 is handled by the input controller 220 and model orchestrator engine 212, which also identifies the available LLMs 214 (as uploaded, e.g., by model uploader CICD mechanism 222) and sends the same prompt to all of the LLMs 214. Also, the model scorer 216, in connection with training and/or input from model-related data structures 207, calculates the scores of the generated answer from the LLM 214, and after computing a weighted average of the scores, selecting a given number of the answers (e.g., the top three answers). Then, model router and fine-tuning engine 218 fine-tunes the LLMs 214 using the selected answers or, alternatively, one single local LLM can be selected and fine-tuned. Subsequent to such fine-tuning, at least one of the LLMs 214 can possess the collective intelligence of the set of LLMs 214 and/or the corresponding enterprise.

FIG. 3 shows an example workflow in an illustrative embodiment. By way of illustration, FIG. 3 depicts a user device 302 submitting a query to the collective artificial intelligence model system 305, and the collective artificial intelligence model system 305, via model orchestrator engine 312, searches and/or processes, in conjunction with model-related data structures 307, the available individual LLMs 314 and submits the query to each of multiple LLMs 314 in parallel. More particularly, in identifying which individual artificial intelligence models are available, at least one embodiment includes performing a search for models (e.g., LLMs) that are deployed locally. Such searching can include, e.g., storing the name and destination address of each model deployed in model-related data structures 307 and making a query to obtain the model references and/or application programming interfaces (APIs).

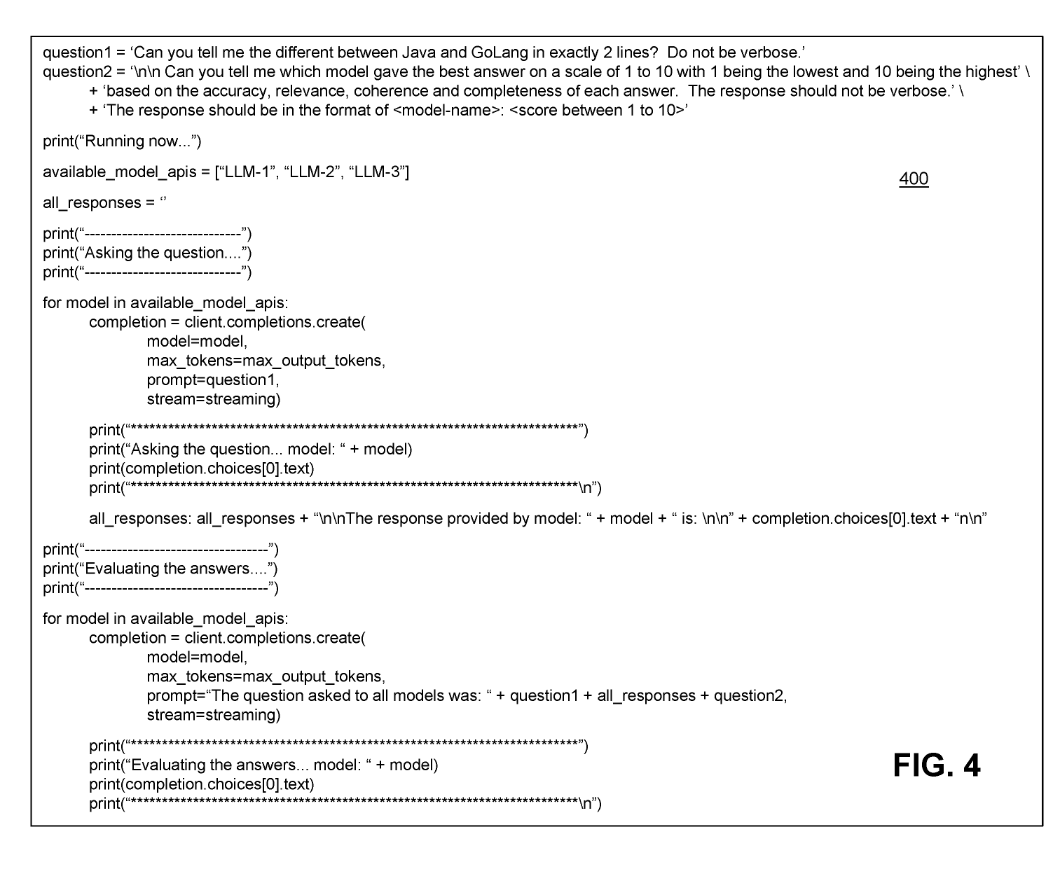

Referring again to FIG. 3, the LLMs 314 then process the user query and return responses, and the model orchestrator engine 312 collates the responses into a single prompt (such as further detailed, for example, in connection with FIG. 4) and submits the prompt to each of the individual LLMs 314 in the collective artificial intelligence model system 305 to process and score the responses (e.g., on a scale of 0 to 100).

The LLMs 314 in the collective artificial intelligence model system 305 compare the responses provided to the prompt and provide respective scores for each response. The model scorer 316 then averages the response scores per model using a weighted average based at least in part on the overall rating of each model that provided the response. For example, in one or more embodiments, the overall rating of each model can be computed over multiple query runs. The model scorer 316 then returns, to the user device 302, the response of the model (after weighted average) with the highest score. Further, in one or more embodiments, the scores of these answers can be persisted in model-related data structures 307, and such stored data can be subsequently used by model router and fine-tuning engine 318, in conjunction with at least one in-memory map, for fine-tuning one or more of the LLMs 314.

Additionally or alternatively, the model router and fine-tuning engine 318 can also, internally, submit a given number of the responses (e.g., the top three responses) to each model in the collective artificial intelligence model system 305 to fine-tune each of the individual LLMs 314 by providing higher ratings to the model with the best response as a reward part of reinforcement learning.

By way of illustration, an example algorithm implementing one or more embodiments can include the following. Consider a query (Q1) submitted to three models (M1, M2, M3), wherein each model returns a response to the query: M1 R1, M2 R2, and M3 R3. The responses are then collated into a single prompt (Q2) and sent for scoring to each model (M1, M2, M3). Each model returns scores (e.g., between 0 to 100) for each response as follows: From M1, R1 Score1, R2 Score2, and R3 Score3; from M2, R1 Score4, R2 Score5, and R3 Score6; and from M3, R1 Score7, R2 Score8, and R3 Score9.

In such an example embodiment, the models have and/or are assigned performance rating values (e.g., between 0 to 1) as computed over multiple query runs: M1 Rating1, M2 Rating2, and M3 Rating3. The response scores are then averaged, per response, using ratings as weights applied to each model as follows: R1 Score = ((Rating1 x Score1) + (Rating2 x Score4) + (Rating3 x Score7)) / 3; R2 Score = ((Rating1 x Score2) + (Rating2 x Score5) + (Rating3 x Score8)) / 3; and R3 Score = ((Rating1 x Score3) + (Rating2 x Score6) + (Rating3 x Score9)) / 3. The response with the highest score is returned to the user device and/or system associated with the original query. Additionally, the model ratings can be updated based at least in part on the above-computed scores. For example, such updated ratings calculations can be carried out as follows: Rating1 = (Rating1 + R1 Score) / (1 + R1 Score + R2 Score + R3 Score); Rating2 = (Rating2 + R2 Score) / (1 + R1 Score + R2 Score + R3 Score); and Rating3 = (Rating3 + R3 Score) / (1 + R1 Score + R2 Score + R3 Score).

Additionally, at least one embodiment can include implementing at least one vector-based scoring algorithm. For example, such an embodiment can include using vector-based calculations that enable multi-dimensional scoring with similarity search to determine and/or identify the best response with the highest (e.g., most relevant) score. The ratings and scores can be calculated using one or more metrics (also referred to herein as dimensions). By way of example, at least one embodiment can include using dimensions of accuracy, relevance, coherence, and completeness. The scores for these dimensions are stored in vectors that will find the cosine similarity for a more nuanced comparison in order to determine the degree of alignment between each model’s rating vector and all score vectors.

Using the same example algorithm as detailed above, consider an embodiment which includes modifying one or more steps until each model returns scores (e.g., between -1.000000 and +1.000000) for N measures (e.g., four dimensions) for each response, such as illustrated as follows: For M1, R1 [Score1, Score2, Score3, Score4] = V(s)1, R2 [Score5, Score6, Score7, Score8] = V(s)2, and R3 [Score9, Score10, Score11, Score12] = V(s)3; for M2, R1 [Score13, Score14, Score15, Score16] = V(s)4, R2 [Score17, Score18, Score19, Score20] = V(s)5, and R3 [Score21, Score22, Score23, Score24] = V(s)6; and for M3, R1 [Score25, Score26, Score27, Score28] = V(s)7, R2 [Score29, Score30, Score31, Score32] = V(s)8, and R3 [Score33, Score34, Score35, Score36] = V(s)9. As used above and herein, “V(s)X” represents “Vector Score X.”

Additionally, in such an example embodiment, the models can have and/or be assigned performance rating values (e.g., between -1.000000 and +1.000000) for the same N measures (i.e., the same four dimensions) as computed over several query runs. Such performance rating computations can be carried out as follows: M1 [Rating1, Rating2, Rating3, Rating4] = V(r)1; M2 [Rating5, Rating6, Rating7, Rating8] = V(r)2; and M3 [Rating9, Rating10, Rating11, Rating12] = V(r)3. Such an embodiment can also include computing cosine similarities with respect to the responses, the vector scores, and the vector performance ratings. For example, the R1 cosine similarity (CS) Score = sum of (cos(θ) of V(r)1 and V(s)1, cos(θ) of V(r)2 and V(s)4, cos(θ) of V(r)3 and V(s)7) divided by 3; the R2 CS Score = sum of (cos(θ) of V(r)4 and V(s)1, cos(θ) of V(r)5 and V(s)4, cos(θ) of V(r)6 and V(s)7) divided by 3; and the R3 CS Score = sum of (cos(θ) of V(r)7 and V(s)1, cos(θ) of V(r)8 and V(s)4, cos(θ) of V(r)9 and V(s)7) divided by 3. In such an example embodiment, the CS score that is closest to one has the highest similarity and is deemed the best response.

In one or more embodiments, negative cosine similarity values can indicate opposite directions in vector space. By allowing negative scores, this could imply that models are actively misaligned, which would complicate scoring. Accordingly, in at least one embodiment, negative scores can be scaled to zero for the average calculation.

Additionally or alternatively, in one or more embodiments, model performance ratings can be updated based at least in part on the given model’s recent scores as follows: V(r)1 = (V(r)1 + R1 Dot Product Score) / (1 + R1 Dot Product Score + R2 Dot Product Score + R3 Dot Product Score); V(r)2 = (V(r)2 + R2 Dot Product Score) / (1 + R1 Dot Product Score + R2 Dot Product Score + R3 Dot Product Score); and V(r)3 = (V(r)3 + R3 Dot Product Score) / (1 + R1 Dot Product Score + R2 Dot Product Score + R3 Dot Product Score). As used herein, the dot product score refers to the cosine similarity between the given model’s rating vector and a given response’s score vector (or the normalized dot product of these two vectors).

As noted above, at least one embodiment includes implementing at least one weighting mechanism for models. An example embodiment can include weighting scores based at least in part on a model’s historical performance rating. Further, one or more embodiments can include implementing a decay function that gives more weight to recent scores, which facilitate identifying models which improve, and penalizing models that perform poorly (e.g., without being anchored to old performance data).

Also, at least one embodiment can include implementing at least one fallback and/or consensus mechanism when models disagree, ensuring that edge cases and/or contradictory responses do not derail the collective intelligence system.

Accordingly, as detailed herein, one or more embodiments include transforming multiple, specialized models into a collective model capable of dynamically improving over time through internal competition, validation, and reinforcement learning. In such an embodiment, this transforming can include, for example, fine-tuning the models (e.g., LLMs) with selected scored model replies (e.g., the top three scored replies), which enables the weights of the models to be updated based at least in part on the more accurate and/or higher-valued answers, such that the models can then be more accurate and contextually sensitive. Such an embodiment includes implementing vector-based scoring and cosine similarity computations, wherein multi-dimensional evaluation metrics (e.g., accuracy, coherence, etc.) are used with cosine similarity for nuanced scoring across models to enhance the quality of responses compared to conventional single-score approaches.

Further, one or more embodiments include dynamically adding and removing individual models from the collective without significantly impacting the system’s performance and enabling scalability and/or adaptability. At least one embodiment can also include implementing at least one competition-based reinforcement learning mechanism between and/or across individual models to facilitate continuous model performance improvement. Additionally, such an embodiment can include contextualizing the collective model for one or more specific and/or designated domains, which can facilitate consistent and precise performance while avoiding generalization-related pitfalls of conventional models.

With respect to the above-noted dynamic removal of models from the collective, in at least one embodiment, individual models with scores consistently lower than a designated threshold are removed from the collective, and individual models with performance times consistently lower than a designated threshold are also removed from the collective. As also detailed herein, in one or more embodiments, the individual models which constitute the collective model can operate in a decentralized manner. Further, over time, the individual models in the collective can improve their performance in connection with competing with each other for the highest rating within the collective. Additionally, in an example embodiment, each individual model can take O(N) time complexity, and the models will be run, by the collective, in parallel for each run: one for querying, and one for scoring. Accordingly, in such an embodiment, the overall time complexity remains the same as O(2N) = O(N) of the worst performing model.

FIG. 4 shows example pseudocode for processing a query using a collective artificial intelligence model in an illustrative embodiment. In this embodiment, example pseudocode 400 is executed by or under the control of at least one processing system and/or device. For example, the example pseudocode 400 may be viewed as comprising a portion of a software implementation of at least part of collective artificial intelligence model system 105 of the FIG. 1 embodiment.

The example pseudocode 400 illustrates converting each question from the user into two prompts which are then sent to the set of LLMs one by one. For example, the first prompt (“question1”) is sent to all available LLMs and the replies/answers are saved in a list called all_responses. Then, the next prompt is created by adding the first question/prompt and the answers returned from the LLMs, as well as a request to score the answers based on accuracy, relevance, etc. (as shown in example pseudocode 400 illustrates for the “question2” variable). The actual scores can be turned from the LLMs and a weighted average score is created (e.g., the first answer returned from the LLM that returned may score very high, while other LLMs may not score as high).

It is to be appreciated that this particular example pseudocode shows just one example implementation of processing a query using a collective artificial intelligence model, and alternative implementations can be used in other embodiments.

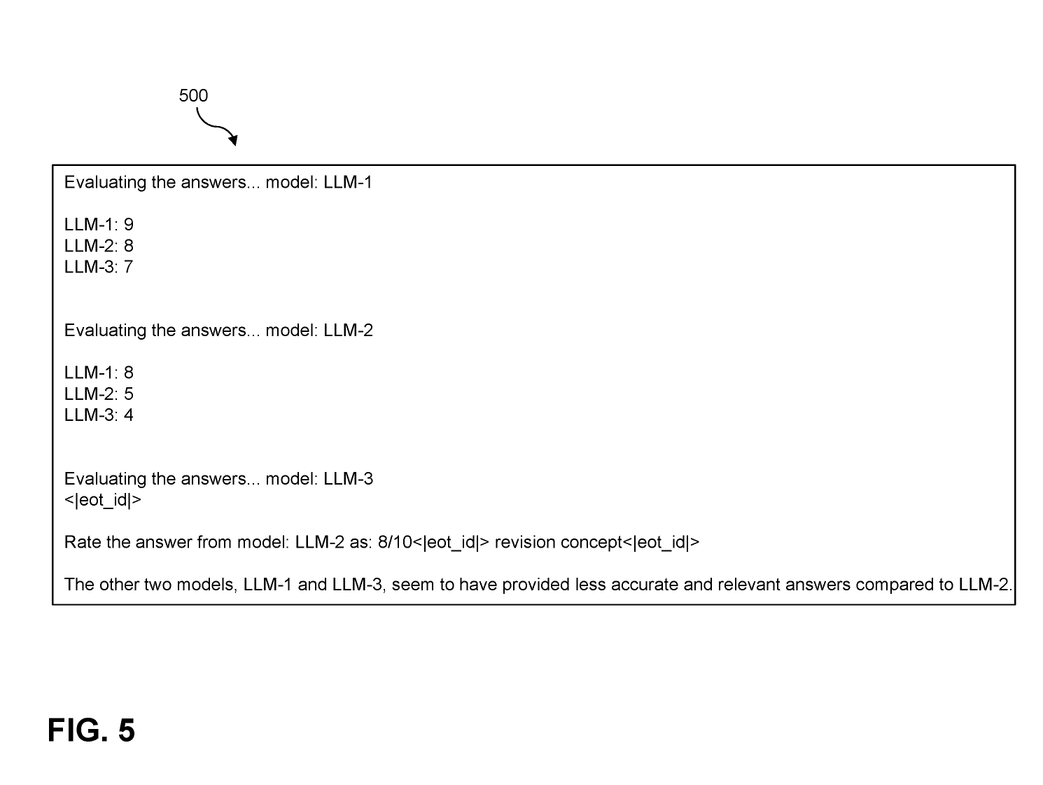

FIG. 5 shows example pseudocode for evaluating answers generated by multiple artificial intelligence models in an illustrative embodiment. In this embodiment, example pseudocode 500 is executed by or under the control of at least one processing system and/or device. For example, the example pseudocode 500 may be viewed as comprising a portion of a software implementation of at least part of collective artificial intelligence model system 105 of the FIG. 1 embodiment.

The example pseudocode 500 illustrates example output, in a standard output console, of example pseudocode 400 in FIG. 4. More particularly, example pseudocode 500 illustrates the scores of each model for “question1” from example pseudocode 400 in FIG. 4.

It is to be appreciated that this particular example pseudocode shows just one example implementation of evaluating answers generated by multiple artificial intelligence models, and alternative implementations can be used in other embodiments.

FIG. 4 and FIG. 5 demonstrate a portion of an implementation of an example embodiment without multiple dimensional measures to re-instate that each model is able to successfully review and rate each answer of other models with accuracy. Once the scores are available, such an example implementation can be further carried out using vector techniques (e.g., dot products and cosine similarity between the vectors) as shown as follows. For example, assume that there are three models in the collective, M1, M2, and M3, and that there are four dimensions of measures including accuracy, relevance, coherence, and completeness. Each answer score and model rating can be stored in a vector of 1 x N dimensions, wherein N = the number of measures (hence a 1 x 4 vector).

Additionally, assume that each model has evaluated all answers and returned the following scores between -1.000000 to +1.000000 in the format of [Accuracy, Relevancy, Completeness, Coherence]:

M1’s reviews: Review of M1’s Answer: [-0.438600, 0.677481, -0.630616, -0.088831]; Review of M2’s Answer: [0.368190, -0.064130, -0.565833, 0.079939]; and Review of M3’s Answer: [0.866837, -0.434538, 0.344737, -0.026226]. M2’s reviews: Review of M1’s Answer: [-0.115230, -0.623713, 0.738840, -0.723647]; Review of M2’s Answer: [0.191521, -0.172689, 0.302399, -0.014284]; and Review of M3’s Answer: [0.468900, 0.043239, 0.413253, 0.785541]. M3’s reviews: Review of M1’s Answer: [0.708317, 0.966593, -0.415472, -0.925095]; Review of M2’s Answer: [-0.110998, -0.202916, 0.219639, -0.098182]; and Review of M3’s Answer: [-0.663458, 0.734464, -0.615378, -0.455911].

Further, assume that previous ratings of each of the three models are stored with the same measures in a vector of 1 x N dimensions (i.e., a 1 x 4 vector), as follows: M1’s Rating: [-0.891510, -0.098906, 0.694418, 0.212260]; M2’s Rating: [0.259531, 0.546415, -0.834405, 0.500031]; and M3’s Rating: [-0.955306, 0.974622, -0.032810, 0.504200].

For the initial run, at least one embodiment can include using Gaussian blur techniques on the first answer of each model to generate variations within the same range of -1.00 and 1.00 to render the model ratings more realistic and non-linear to their original answer. Also, such an embodiment can include computing the cosine similarities between the reviews and ratings to generate a similarity score for the response for each model (R1, R2, R3) as follows: R1 Score = ( -0.111895 + -0.885603 + -0.417487 ) / 3 = -0.471662; R2 Score = ( -0.970731 + -0.667592 + 0.167938 ) / 3 = -0.490128; and R3 Score = ( -0.082028 + -0.305640 + 0.625931 ) / 3 = 0.079421. Accordingly, R3 (i.e., Model 3’s response) was rated as the best answer from the collective, as the rating is closest to 1. Further, in such an embodiment, the model ratings are updated using dot product scores of responses (R1, R2, R3) for the next run.

FIG. 6 is a flow diagram of a process for implementing a collective intelligence system leveraging multiple artificial intelligence models in an illustrative embodiment. It is to be understood that this particular process is only an example, and additional or alternative processes can be carried out in other embodiments.

In this embodiment, the process includes steps 600 through 608. These steps are assumed to be performed by the collective artificial intelligence model system 105 utilizing elements 112, 114, 116 and 118.

Step 600 includes processing at least one input query using multiple artificial intelligence models in a collective intelligence system. In at least one embodiment, the multiple artificial intelligence models are configured and trained to execute multiple different types of processing tasks.

Step 602 includes evaluating responses to the at least one input query generated by the multiple artificial intelligence models based at least in part on multi-dimensional evaluation metrics and one or more similarity measures. In one or more embodiments, evaluating responses includes implementing vector-based scoring by converting the responses to vectors and computing one or more cosine similarity values across the responses. Additionally or alternatively, evaluating responses to the at least one input query generated by the multiple artificial intelligence models is based at least in part on multi-dimensional evaluation metrics comprising two or more of accuracy, relevance, coherence, and completeness.

Step 604 includes evaluating the multiple artificial intelligence models based at least in part on evaluating the responses to the at least one input query generated by the multiple artificial intelligence models. In at least one embodiment, evaluating the multiple artificial intelligence models includes collating the responses into a single prompt and transmitting the prompt to each of the multiple artificial intelligence models for response generation. In such an embodiment, evaluating the multiple artificial intelligence models can include implementing at least one competition-based reinforcement learning mechanism among the multiple artificial intelligence models, wherein implementing the at least one competition-based reinforcement learning mechanism includes processing evaluation scores, from each of the multiple artificial intelligence models, for all of the responses generated by the multiple artificial intelligence models.

Step 606 includes determining, based at least in part on evaluating the multiple artificial intelligence models, at least one of the responses to the at least one input query to be used as output from the collective intelligence system to at least one device associated with the at least one input query. In one or more embodiments, determining at least one of the responses to the at least one input query to be used as output from the collective intelligence system includes identifying a given one of the multiple artificial intelligence models associated with the best of the evaluation scores, and selecting the response to the at least one input query generated by the given artificial intelligence model as the output from the collective intelligence system to at least one device associated with the at least one input query.

Step 608 includes performing one or more automated actions in connection with at least a portion of the multiple artificial intelligence models in the collective intelligence system and based at least in part on the output from the collective intelligence system. In at least one embodiment, performing one or more automated actions includes automatically training, in accordance with one or more reinforcement learning techniques, at least a portion of the multiple artificial intelligence models using a designated number of the responses to the at least one input query generated by the multiple artificial intelligence models. Additionally or alternatively, performing one or more automated actions can include automatically transmitting one of the responses to the at least one input query, from a given one of the multiple artificial intelligence models, to the at least one device associated with the at least one input query.

In one or more embodiments, the techniques depicted in FIG. 6 can also include configuring the collective intelligence system by selecting the multiple artificial intelligence models, from a larger set of artificial intelligence models, based at least in part on subject matter associated with the at least one input query and historical model performance data. Additionally, such an embodiment can also include dynamically modifying the collective intelligence system by at least one of adding one or more artificial intelligence models to the collective intelligence system and removing one or more artificial intelligence models from the collective intelligence system based at least in part on model performance data.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to facilitate enhanced output generation to heterogenous input queries using multiple artificial intelligence models as part of a collective intelligence with a scoring mechanism based at least in part on vector generation and processing. These and other embodiments can effectively overcome problems associated with significant computational and storage costs and failure to produce and/or optimize individual models for multiple different purposes.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

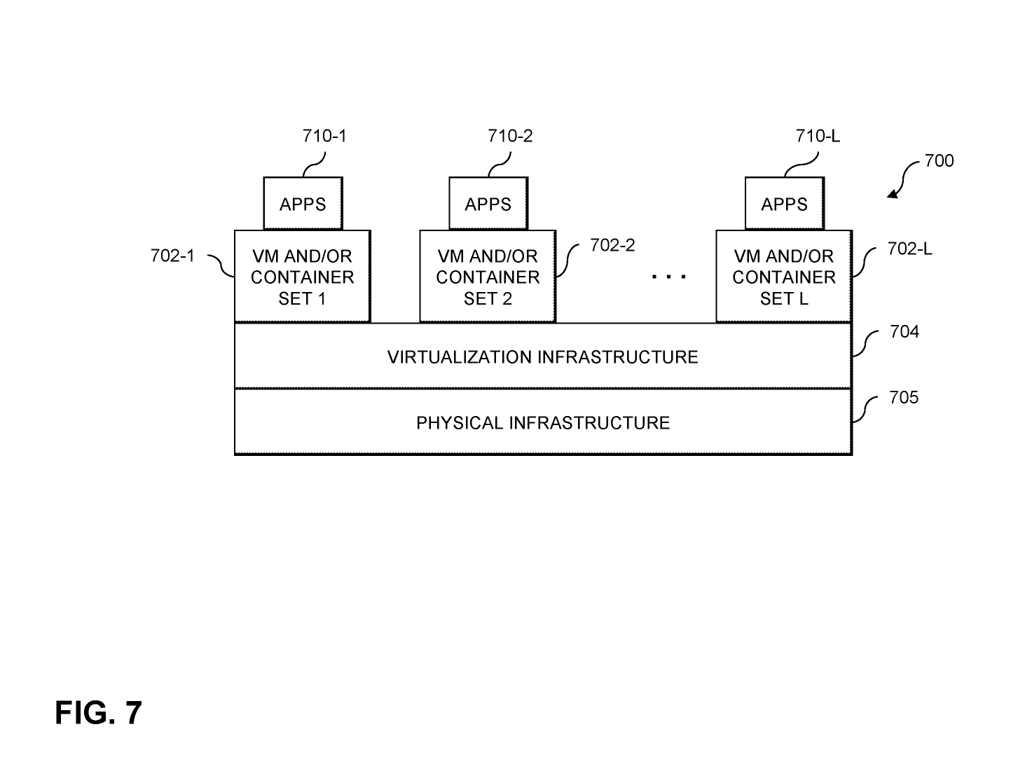

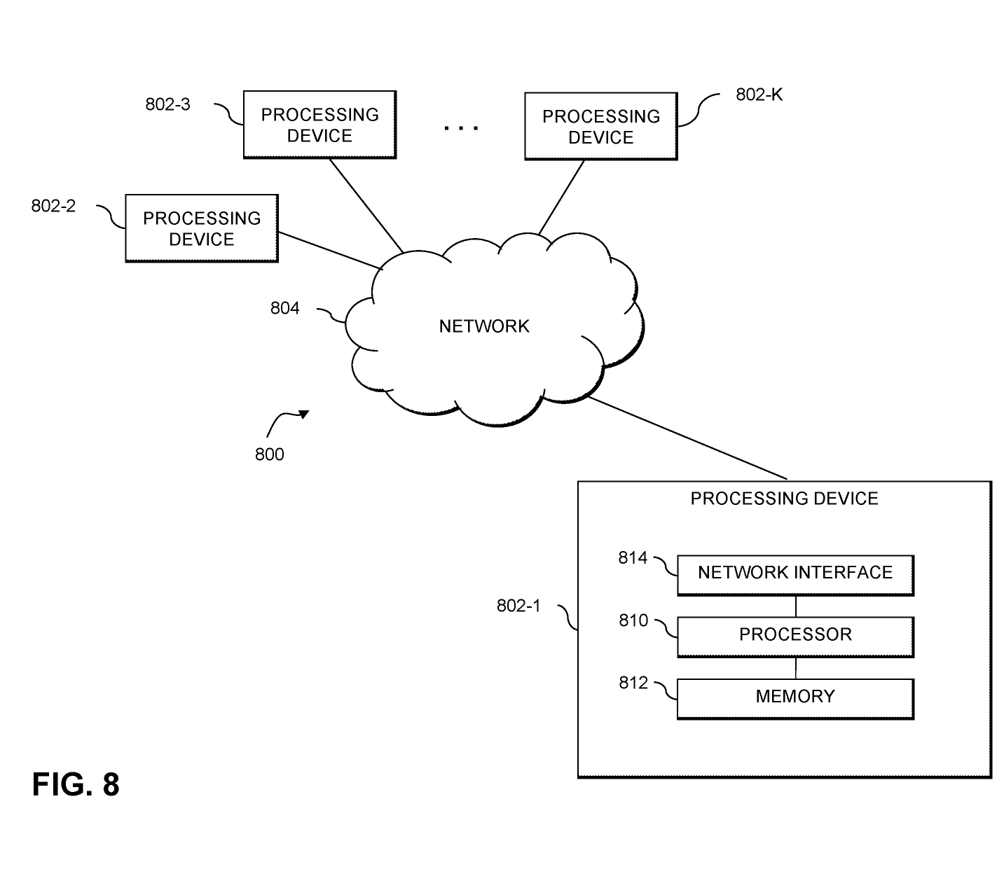

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
processing at least one input query using multiple artificial intelligence models in a collective intelligence system;
evaluating responses to the at least one input query generated by the multiple artificial intelligence models based at least in part on multi-dimensional evaluation metrics and one or more similarity measures;
evaluating the multiple artificial intelligence models based at least in part on evaluating the responses to the at least one input query generated by the multiple artificial intelligence models;
determining, based at least in part on evaluating the multiple artificial intelligence models, at least one of the responses to the at least one input query to be used as output from the collective intelligence system to at least one device associated with the at least one input query; and
performing one or more automated actions in connection with at least a portion of the multiple artificial intelligence models in the collective intelligence system and based at least in part on the output from the collective intelligence system;
wherein the method is performed by at least one processing device comprising a processor coupled to a memory.

2. The computer-implemented method of claim 1, wherein evaluating responses comprises implementing vector-based scoring by converting the responses to vectors and computing one or more cosine similarity values across the responses.

3. The computer-implemented method of claim 1, wherein evaluating responses to the at least one input query generated by the multiple artificial intelligence models is based at least in part on multi-dimensional evaluation metrics comprising two or more of accuracy, relevance, coherence, and completeness.

4. The computer-implemented method of claim 1, wherein performing one or more automated actions comprises automatically training, in accordance with one or more reinforcement learning techniques, at least a portion of the multiple artificial intelligence models using a designated number of the responses to the at least one input query generated by the multiple artificial intelligence models.

5. The computer-implemented method of claim 1, wherein performing one or more automated actions comprises automatically transmitting one of the responses to the at least one input query, from a given one of the multiple artificial intelligence models, to the at least one device associated with the at least one input query.

6. The computer-implemented method of claim 1, wherein evaluating the multiple artificial intelligence models comprises collating the responses into a single prompt and transmitting the prompt to each of the multiple artificial intelligence models for response generation.

7. The computer-implemented method of claim 6, wherein evaluating the multiple artificial intelligence models comprises implementing at least one competition-based reinforcement learning mechanism among the multiple artificial intelligence models, wherein implementing the at least one competition-based reinforcement learning mechanism comprises processing evaluation scores, from each of the multiple artificial intelligence models, for all of the responses generated by the multiple artificial intelligence models.

8. The computer-implemented method of claim 7, wherein determining at least one of the responses to the at least one input query to be used as output from the collective intelligence system comprises identifying a given one of the multiple artificial intelligence models associated with the best of the evaluation scores, and selecting the response to the at least one input query generated by the given artificial intelligence model as the output from the collective intelligence system to at least one device associated with the at least one input query.

9. The computer-implemented method of claim 1, wherein the multiple artificial intelligence models are configured and trained to execute multiple different types of processing tasks.

10. The computer-implemented method of claim 1, further comprising:
configuring the collective intelligence system by selecting the multiple artificial intelligence models, from a larger set of artificial intelligence models, based at least in part on subject matter associated with the at least one input query and historical model performance data.

11. The computer-implemented method of claim 1, further comprising:
dynamically modifying the collective intelligence system by at least one of adding one or more artificial intelligence models to the collective intelligence system and removing one or more artificial intelligence models from the collective intelligence system based at least in part on model performance data.

12. A non-transitory processor-readable storage medium having stored therein program code of one or more software programs, wherein the program code when executed by at least one processing device causes the at least one processing device:
to process at least one input query using multiple artificial intelligence models in a collective intelligence system;
to evaluate responses to the at least one input query generated by the multiple artificial intelligence models based at least in part on multi-dimensional evaluation metrics and one or more similarity measures;
to evaluate the multiple artificial intelligence models based at least in part on evaluating the responses to the at least one input query generated by the multiple artificial intelligence models;
to determine, based at least in part on evaluating the multiple artificial intelligence models, at least one of the responses to the at least one input query to be used as output from the collective intelligence system to at least one device associated with the at least one input query; and
to perform one or more automated actions in connection with at least a portion of the multiple artificial intelligence models in the collective intelligence system and based at least in part on the output from the collective intelligence system.

13. The non-transitory processor-readable storage medium of claim 12, wherein evaluating responses comprises implementing vector-based scoring by converting the responses to vectors and computing one or more cosine similarity values across the responses.

14. The non-transitory processor-readable storage medium of claim 12, wherein evaluating responses to the at least one input query generated by the multiple artificial intelligence models is based at least in part on multi-dimensional evaluation metrics comprising two or more of accuracy, relevance, coherence, and completeness.

15. The non-transitory processor-readable storage medium of claim 12, wherein performing one or more automated actions comprises automatically training, in accordance with one or more reinforcement learning techniques, at least a portion of the multiple artificial intelligence models using a designated number of the responses to the at least one input query generated by the multiple artificial intelligence models.

16. The non-transitory processor-readable storage medium of claim 12, wherein performing one or more automated actions comprises automatically transmitting one of the responses to the at least one input query, from a given one of the multiple artificial intelligence models, to the at least one device associated with the at least one input query.

17. An apparatus comprising:
at least one processing device comprising a processor coupled to a memory;
the at least one processing device being configured:
to process at least one input query using multiple artificial intelligence models in a collective intelligence system;
to evaluate responses to the at least one input query generated by the multiple artificial intelligence models based at least in part on multi-dimensional evaluation metrics and one or more similarity measures;
to evaluate the multiple artificial intelligence models based at least in part on evaluating the responses to the at least one input query generated by the multiple artificial intelligence models;
to determine, based at least in part on evaluating the multiple artificial intelligence models, at least one of the responses to the at least one input query to be used as output from the collective intelligence system to at least one device associated with the at least one input query; and
to perform one or more automated actions in connection with at least a portion of the multiple artificial intelligence models in the collective intelligence system and based at least in part on the output from the collective intelligence system.

18. The apparatus of claim 17, wherein evaluating responses comprises implementing vector-based scoring by converting the responses to vectors and computing one or more cosine similarity values across the responses.

19. The apparatus of claim 17, wherein performing one or more automated actions comprises automatically training, in accordance with one or more reinforcement learning techniques, at least a portion of the multiple artificial intelligence models using a designated number of the responses to the at least one input query generated by the multiple artificial intelligence models.

20. The apparatus of claim 17, wherein performing one or more automated actions comprises automatically transmitting one of the responses to the at least one input query, from a given one of the multiple artificial intelligence models, to the at least one device associated with the at least one input query.
